(19) United States
(12) Patent Application Publication
(10) Pub. No.: US 2014/0147042 A1
(43) Pub. Date: May 29, 2014

(54) Device for uniformly enhancing images

(71) Applicants: Chenyang Ge, Xi'an (CN); Yanhui Zhou, Xi'an (CN)

(72) Inventors: Chenyang Ge, Xi'an (CN); Yanhui Zhou, Xi'an (CN)

(21) Appl. No.: 14/040,707

(22) Filed: Sep. 29, 2013

(30) Foreign Application Priority Data
Nov. 27, 2012 (CN) 201210490226.5

(51) Int. Cl. G06T 5/50

(52) U.S. Cl. CPC G06T 5/50
USPC 382/167; 382/274

(57) ABSTRACT

A device for uniformly enhancing images includes a control unit, a lined cache controller, a lined storage array, an average grayscale computing unit, a scaling coefficient computing unit and an enhancement computing unit. For a color image, the color image is firstly transformed in to YUV space from RGB space and a grayscale image of Y component thereof is divided into identical-sized image blocks; then each image block is uniformly processed with a grayscale enhancement. A method for uniformly enhancing images includes firstly designating a reference grayscale value gray_value for grayscale images, comparing the reference grayscale value to an average grayscale value mean_value of a current image block to obtain a scaling coefficient, and multiplying all pixels or specific pixels within the image block by the scaling coefficient. The grayscale enhancement of an image sequence uses an identical grayscale value for reference, so as to accomplish a uniform enhancement of different images.

### BACKGROUND OF THE PRESENT INVENTION

1. Field of Invention

The present invention relates to fields of digital image processing and natural interaction, and more particularly to an image processing of uniform enhancement.

2. Description of Related Arts

In the digital image processing, the image enhancement is the basic technology of the image pre-processing and plays an important role in improving the image quality. The image enhancement is widely applied in many fields, such as the industrial production, the biomedical science, the aerospace and the national defense, and thus gains much attention. During the processes of generating, transmitting and transforming, the original image may be affected by many factors comprising the various noises and the channel bandwidth, and thus the image quality decline is quite common, such as a decline in the definition and a relatively low contrast, which necessitates an improvement in the image quality.

The image enhancement technology aims to enhance certain main information which is most needed and simultaneously weaken or inhibit some minor information, in such a manner that the post-processing image satisfies a specific requirement. For example, in the video post-processing process of the digital television, it is necessary to enhance the definition and the depth of perception of the television image and to enhance the contrast or the hue, so as to improve the visual effects of the human eyes. Conventionally, the common image enhancement methods comprise the enhancement methods in the spatial domain and those in the frequency domain; the enhancement methods in the spatial domain comprise the grayscale transformation, the histogram equalization and the linear or nonlinear filtering. It is difficult to solve the problem of uniformly enhancing a sequence of images having different characteristics, such as different brightness and different signal to noise ratios (SNRs), via a single method which is selected from the above common image enhancement methods, due to the problems of the overflow and the over-enhancement in the histogram equalization and the problem of the inconsistent enhancement in the brightness of different images.

### SUMMARY OF THE PRESENT INVENTION

An object of the present invention is to overcome the above disadvantages and to provide a method for uniformly enhancing images which facilitates accomplishing the method via hardware and is able to uniformly enhance a sequence of images according to a specific application requirement.

The present invention adopts following technical solutions.

A method for uniformly enhancing images comprises steps of:

(1) obtaining an inputted image to be enhanced, if the inputted image is a color image, transforming the color image from RGB space into YUV space, dividing a grayscale image of the Y component of the color image into a plurality of identical-sized image blocks block_{m×n}; the inputted image is a grayscale image, dividing the grayscale image into identical-sized image blocks block_{m×n}; wherein m and n indicate a size of the image block;

(2) computing an average grayscale value of each image block mean_value, comparing a uniform grayscale value gray_value which is pre-computed with the average grayscale value of the image block and then obtaining a scaling coefficient k; and

(3) multiplying all pixels or specific pixels within the image block by the scaling coefficient k as showed in a following formula,

$${block}_{post} = {block}_{pre} \frac{gray\_value}{mean\_value}$$

wherein blockₚᵣₑ indicates an original pixel value of the pixel within the image block and blockₚₒₛₜ indicates the pixel value of the pixel after enhancement within the image block.

Further, a device for uniformly enhancing images, provided by the present invention, comprises a control unit, a lined cache controller, a lined storage array, an average grayscale computing unit, a scaling coefficient computing unit and an enhancement computing unit.

The control unit is for generating signals for controlling the device and obtaining an inputted image as an image to be enhanced from external. The image to be enhanced is stored into the lined storage array through the lined cache controller and lined storage data is outputted into the average grayscale computing unit via being controlled by the lined cache controller.

The grayscale computing unit comprises a column adder, a PE (Processing Elements) unit, and a shift register array having a depth of m. The average grayscale computing unit computes an average grayscale mean_value of each image block block_{m×n} according to the received lined storage data, wherein m and n indicate a size of the image block.

The scaling coefficient computing unit computes scaling coefficients according to a uniform grayscale value gray_value which is pre-computed and the average grayscale mean_value of each image block block_{m×n}.

The enhancement computing unit comprises a delaying unit and a multiplier. The scaling coefficients are aligned with the correspondent image blocks of the inputted image to be enhanced which is delayed by the delaying unit. Pixels within the image block are multiplied by the aligned scaling coefficients in the multiplier, so as to accomplish an image enhancement.

These and other objectives, features, and advantages of the present invention will become apparent from the following detailed description, the accompanying drawings, and the appended claims.

### BRIEF DESCRIPTION OF THE DRAWINGS

FIG. 1 is a flow chart of a method for uniformly enhancing images according to a preferred embodiment of the present invention.

FIG. 2 is a block diagram of a device for uniformly enhancing images according to the preferred embodiment of the present invention.

FIG. 3 is a sketch view of an average grayscale computing unit according to the preferred embodiment of the present invention.

FIG. 4 is a sketch view of a scaling coefficient computing unit and an enhancement computing unit according to the preferred embodiment of the present invention.

### DETAILED DESCRIPTION OF THE PREFERRED EMBODIMENT

Combined with the drawings, detailed illustration about the present invention is as follows.

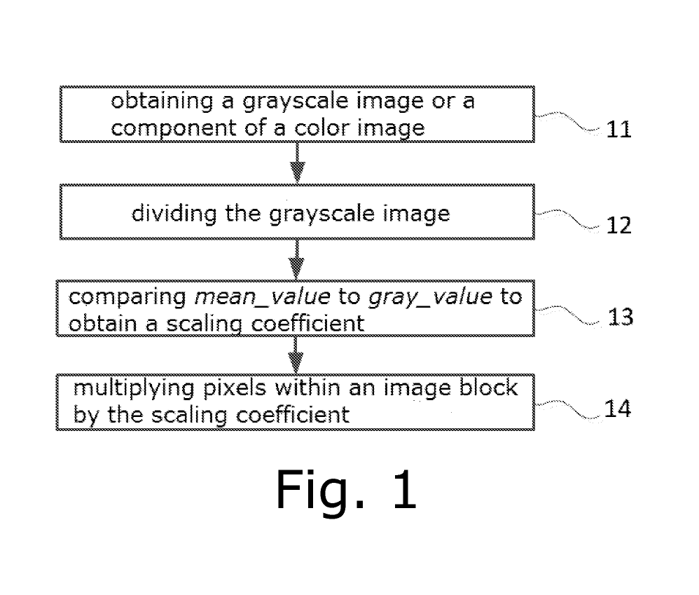

Referring to FIG. 1, according to a preferred embodiment of the present invention, for a color image, firstly the color image is firstly transformed from RGB space into YUV space and then a grayscale image of the Y component of the color image is divided into a plurality of identical-sized image blocks. Then each of the image blocks is processed with a uniform grayscale enhancement. For a grayscale image, firstly the grayscale image is divided into a plurality of identical-sized image blocks_{m×n}, wherein m and n indicate a size of the image block; m and n are identical or different, showed as Step 12. A selection of the size of the image block is related to an object within the image; for example, the size of the image block of a speckle image is at least twice of a size of a speckle point. Then an average grayscale value mean_value of each image block is computed; a scaling coefficient of the image block is obtained via a comparison between a uniform grayscale value gray_value of a pre-stored grayscale image and the average grayscale value mean_value of the image block, showed as Step 13. The uniform grayscale value gray_value is embodied as an actual or expected average grayscale value of the grayscale image. Finally, all pixels or specific pixels within the image block are multiplied by the scaling coefficient, showed as Step 14, as showed in a following formula,

$${block}_{post} = {block}_{pre} \frac{gray\_value}{mean\_value}$$

wherein blockₚᵣₑ indicates an original pixel value of the pixel within the image block and blockₚₒₛₜ indicates the pixel value of the pixel after enhancement within the image block.

In dividing the grayscale image, two neighbor image blocks may or may not have an overlap. For the image blocks without overlap, all pixels within the image block are multiplied with the correspondent scaling coefficient, which generates data of the enhanced image block; for the image blocks with the overlap, in order to avoid repeatedly enhancing the overlap, according to the Step 14, only the specific pixels within the image block are multiplied with the scaling coefficient, wherein the specific pixels comprise pixels around a physical center of the image block.

Preferably, a quantity of the pixels around the physical center of the image block is decided by a moving pixel step between the two neighbor image blocks. Supposing that the moving pixel step between the two neighbor image blocks is l, the specific pixels comprise l*l pixels around the physical center of the image block. Besides, for the image blocks with the overlap, in order to facilitate obtaining the l*l pixels around the physical center of the image block, m and n indicating the size of the image block and l indicating the moving pixel step between the two neighbor image blocks are preferred to be even or odd simultaneously.

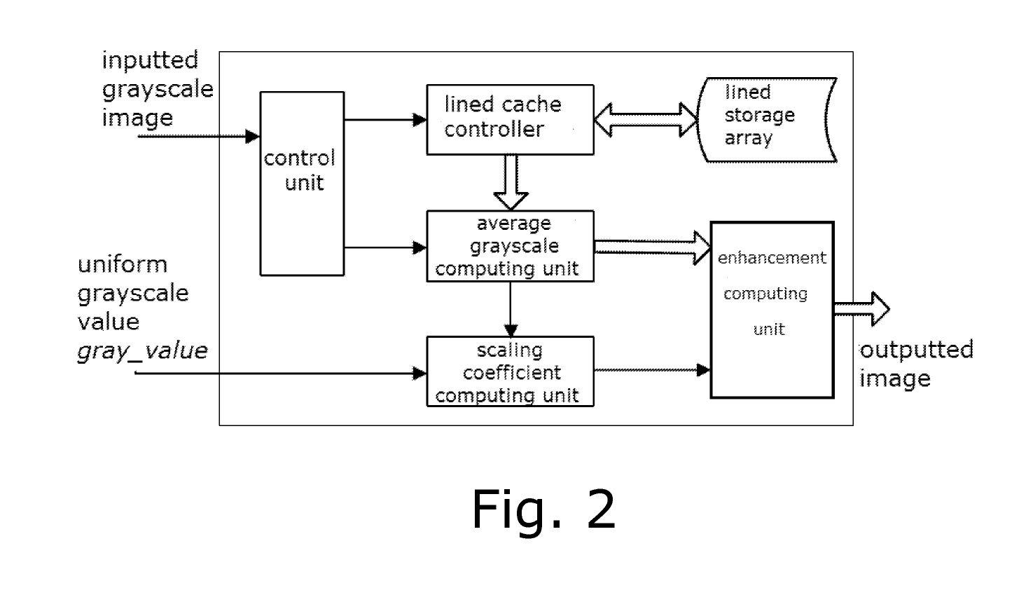

Further, according to the preferred embodiment of the present invention, a device for uniformly enhancing grayscale images which is able to accomplish uniformly enhancing inputted grayscale images in real-time is also provided. As showed in FIG. 2, the device comprises a control unit, a lined cache controller, a lined storage array, an average grayscale computing unit, a scaling coefficient computing unit and an enhancement computing unit.

The control unit generates signals for controlling the device and obtains a data stream of an inputted image, i.e., an image to be enhanced, from an external. The data stream is stored into the lined storage array through the lined cache controller. Lined storage data is parallel outputted under a control by the lined cache controller; thereafter, an average grayscale value mean_value of each image block block_{m×n} having a specific size is computed in the average grayscale computing unit and then compared to a uniform grayscale value gray_value in the scaling coefficient computing unit to obtain a scaling coefficient; further, computing and outputting data of the post-enhancement image is accomplished in the enhancement computing unit with the scaling coefficient and the data stream of the inputted image which is appropriately delayed.

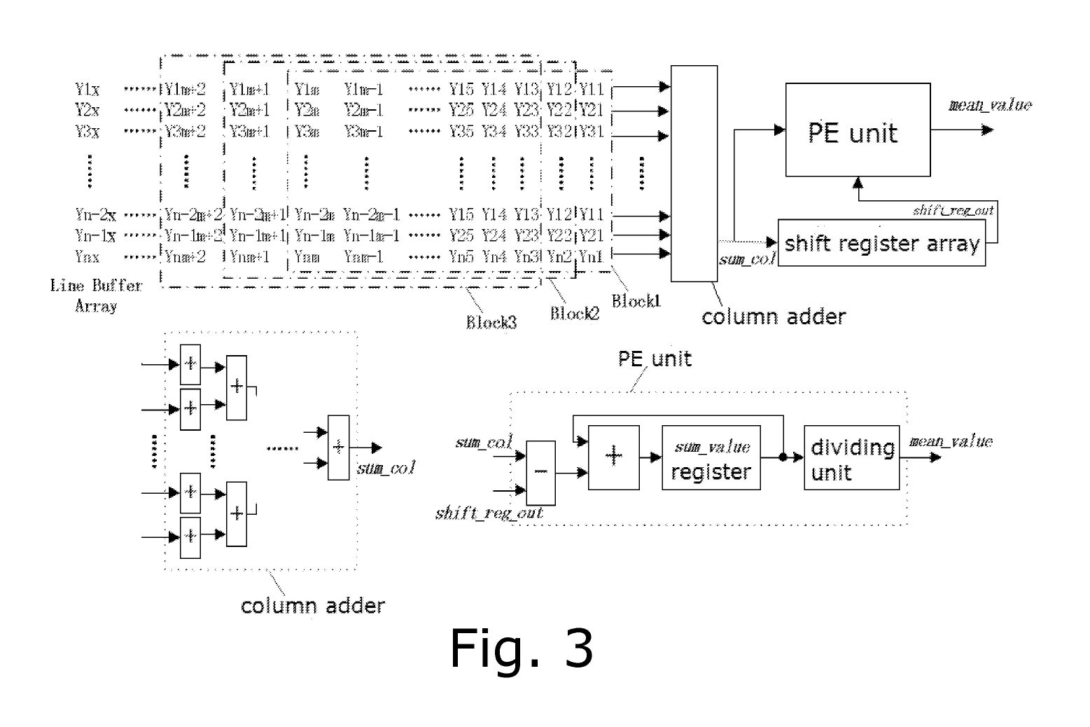

Preferably, the average grayscale computing unit has a structure as showed in FIG. 3.

In order to reduce a usage of on-chip memory, the device of the present invention adopts a manner of sliding window to obtain the image blocks to be enhanced. In any given time, only a part of the image to be enhanced, rather than the whole image, is stored in the lined storage array. According to the preferred embodiment of the present invention, a quantity of bars of the lined storage array is identical to a quantity of rows of the image blocks to be enhanced; via a sliding track of the sliding window of the image to be enhanced, the image blocks to be enhanced are obtained from the lined storage array.

A quantity of pixels which the sliding window slides over each time, namely the moving pixel step l of the two neighbor image blocks, can be smaller than m. Herein, during the Step 13 of computing the average grayscale value mean_value of the image block, a load of computing the average grayscale value of a latter image block is reduced by repeatedly using a sum of grayscale values of pixels of an overlap between a former image block and the latter image block; moreover, as mentioned above, in the Step 14, the specific pixels comprise the l*l pixels around the physical center of the image block when the moving pixel step between the two neighbor image blocks is l.

A principle of repeatedly using the sum of the grayscale values of the overlap between the two neighbor image blocks is illustrated as follows.

For an image block block_{m×n}, having a size of m×n, a formula of an average grayscale value thereof is

$${mean\_value}_{block} = \frac{1}{mn} {\sum }_{( x , y ) ∈ block} g ( x , y )$$

Then, referring to FIG. 3, the average grayscale values of Block1, Block2 Block3 . . . respectively are

$${mean\_value}_{Block 1} = \frac{1}{mn} {\sum }_{i = 1}^{m} G ( i )$$

$${mean\_value}_{Block 2} = \frac{1}{mn} {\sum }_{i = 2}^{m + 1} G ( i )$$

$${mean\_value}_{Block 3} = \frac{1}{mn} {\sum }_{i = 3}^{m + 2} G ( i )$$

$$…$$

wherein g(x,y) is a grayscale value of a pixel (x,y) and G(i) is a sum of grayscale values of n pixels on column i of n rows of image blocks which are outputted by the lined storage array.

The above formulae of the average grayscale values also can be written as

$${mean\_value}_{Block 2} = {mean\_value}_{Block 1} + \frac{1}{mn} ( G ( m + 1 ) - G ( 1 ) )$$

$${mean\_value}_{Block 3} = {mean\_value}_{Block 2} + \frac{1}{mn} ( G ( m + 2 ) - G ( 2 ) )$$

$$…$$

Then a sum of grayscale values of pixels of each image block block_{m×n} is

$${sum\_value}_{Block 1} = {\sum }_{i = 1}^{m} G ( i )$$

$${sum\_value}_{Block 2} = {sum\_value}_{Block 1} + ( G ( m + 1 ) - G ( 1 ) )$$

$${sum\_value}_{Block 3} = {sum\_value}_{Block 2} + ( G ( m + 2 ) - G ( 2 ) )$$

$$…$$

In other words, the sum of the grayscale values of the pixels of the latter image block is obtained based on that of the former image block. The sum of the grayscale values of the pixels within the image block Block2 is equal to a sum of grayscale values of last m−1 columns of Block1 and a last column of Block2. The sum of the grayscale values of the pixels within the image block Block3 is equal to a sum of grayscale values of last m−1 columns of Block2 and a last column of Block3 Similarly, the sum of the grayscale values of the pixels within the latter image block is equal to the sum of the grayscale values of the last m−1 columns of the former image block and the last column of the latter image block.

Therefore, in computing the average grayscale value of the image blocks Block2, Block3 . . . , the sum of the grayscale values of the overlap between the image block and the former image block has been obtained in computing the sum of the grayscale values of the former image block. In order to avoid a repeat computation, it is necessary to repeatedly use data, which further effectively reduces an algorithm complexity.

Preferably, in order to successively accomplish the uniform enhancement of the inputted image in real-time, m and n indicating the size of the image block are odd and l indicating the moving pixel step between the two neighbor image blocks is one pixel. Correspondently, the specific pixel of the image block to be currently enhanced is the pixel at the physical center of the image block; during the Step 14 of computing the post-enhancement result, only the pixel at the physical center of the image block is multiplied by the correspondent scaling coefficient.

As showed in FIG. 3, from an angle of hardware, firstly a sum of grayscale values of each column sum_col of the image block Block1 is computed in a column adder, accumulated in a register sum_value, and then stored via a shift register array having a depth of m. A width of the shift register array is decided by a data width of sum_col. After m clock cycles, the computation of the sum of the grayscale values of column m is finished, when the accumulated value sum_value is the sum of the grayscale values of all pixels within the current image block. The average grayscale value of the current image block is obtained just by dividing the sum of the grayscale values of the all pixels sum_value by the quantity of the pixels within the current image block m×n, so as to accomplish the computation of the average grayscale value mean_value of image block Block1.

The average grayscale value of the next image block Block2 is obtained by just adding the sum of the grayscale values of Block1 to (G(m+1)−G(1)) to obtain the sum of the grayscale values sum_value of all the pixels within Block2 and diving the sum of the grayscale values sum_value of all the pixels within Block2 by the quantity of the pixels within Block2 m×n, wherein G(m+1) is the sum of the grayscale values of the last column of Block2, i.e., an output value sum_col of the column adder at the clock cycle m+1; and G(1) is the sum of the grayscale values of the first column of Block1, i.e., an output value of the shift register array at the clock m+1.

The sum of the grayscale values of the pixels of the first column of the former image block is required to be continuously effective before the computation of the sum of the grayscale values of the latter image block is finished. Correspondently, the sums of the grayscale values of column 2, 3 . . . of the former image block are respectively required to be continuously effective during the computation of the sum of the grayscale values of the next m−1 image blocks is finished. Thus, the device provided by the present invention comprises the shift register array having the depth of m for maintaining the sum of the grayscale values of each column of the former image block effective and outputting the sum of the grayscale values of each column of the former image block effective after m clock cycles, in such a manner that the sums of the grayscale values of the next image blocks are further computed.

Thus, from the angle of hardware, the sums of the grayscale values of the pixels within the next image blocks are respectively equal to the sum of the grayscale values of the former image block plus the output value sum_col of the column adder at a current moment and then minus the output value of the shift register array at the current moment, in such a manner that it only takes one clock cycle to accomplish the computation of the sum of the grayscale values of the all pixels of the latter image block based on the sum of the grayscale values of the former image block.

As showed in FIG. 3, the average grayscale computing unit of the device comprises the column adder, a PE unit and the shift register array.

The column adder accomplishes the computation of the grayscale values of n pixels of a column of the image block which is parallel outputted from the lined storage array. Preferably, as showed in FIG. 3, the column adder is embodied as an adder tree. In each class of the adder tree, each adder only accomplishes summing two computation results which are outputted by an upper class and outputs a summing result into a lower class, so as to accomplish the computation of the sum of the grayscale values of the n pixels in a form of processing line. A quantity of the classes of the adder tree is decided by the quantity of the pixels of a column of the image block.

The PE unit accomplishes the computation of the sum of the grayscale values of the image block based on the sum of the grayscale values of each column sum_col of the image block obtained by the column adder, and also according to a following formula

$${mean\_value}_{Block} = \frac{1}{mn} {sum\_value}_{Block}$$

the computation of the average grayscale value sum_value of the image block. Preferably, from an angle of hardware, the sum of the grayscale values of the current image block is computed based on the output value sum_col of the column adder, the output value shift_reg_out of the shift register array and the value sum_value of the register of the grayscale value sum, i.e., the sum of the grayscale values of the former image block; the computed result is still stored in the register sum_col. A formula of the sum of the grayscale values of the current image block is showed as follows.

sum_value=sum_value+(sum_col−shift_reg_out)

As showed in FIG. 3, a difference between shift_reg_out and sum_col is computed in a subtractor unit and then added to the value sum_value of the register in an adding unit, so as to obtain the sum of the grayscale values sum_value of the current image block. Thereafter, the sum of the grayscale values sum_value is divided by the quantity of the pixels within the image block m×n in a dividing unit, so as to accomplish the computation of the average grayscale value mean_value of the image block.

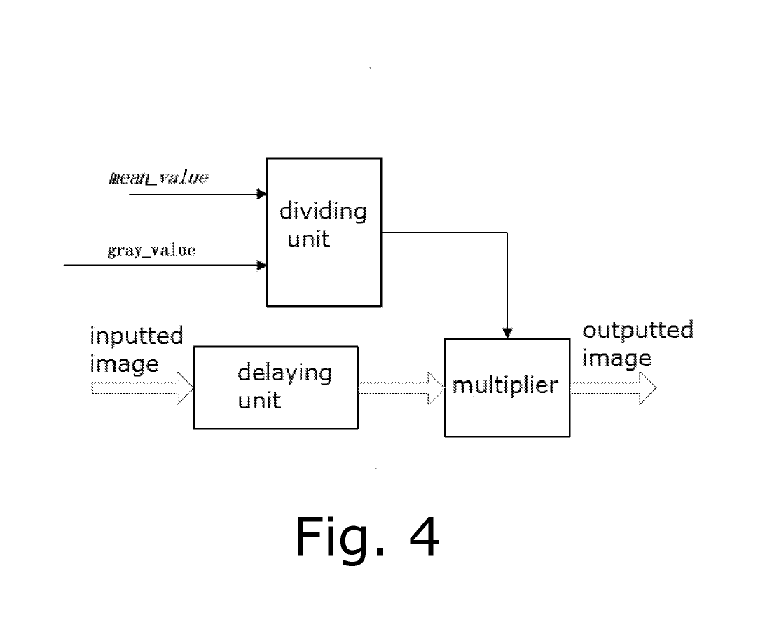

FIG. 4 shows the scaling coefficient computing unit and the enhancement computing unit of the device. After finishing the computation of the average grayscale value mean_value of the image block, the scaling coefficient computing unit compares a uniform grayscale value gray_value of the grayscale image to the average grayscale value mean_value of the image block to obtain a scaling coefficient. According to the preferred embodiment of the present invention, the scaling coefficient computing unit is embodied as an SRT divider.

The enhancement computing unit comprises a delaying unit and a multiplier. In order to avoid the repeat enhancement of the overlap, supposing that the moving pixel step between the two neighbor image blocks is l, only the l*l pixels around the physical center of the image block are multiplied by the correspondent scaling coefficient to obtain the post-enhancement data in the enhancement computing unit. After finishing the computation of the scaling coefficient, the scaling coefficient is aligned with the correspondent image block data which is delayed by the delaying unit and the aligned scaling coefficient is multiplied by the l*l pixel data around the physical center of the correspondent image block, in such a manner that the inputted image data is enhanced and outputted.

Preferably, the moving pixel step between the two neighbor image blocks l is one pixel; m and n indicating the size of the image block are odd. In other words, only the pixel at the physical center of the image block is multiplied by the correspondent scaling coefficient to obtain the post-enhancement data in the enhancement computing unit.

One skilled in the art will understand that the embodiment of the present invention which provides the device for uniformly enhancing the grayscale images as shown in the drawings and described above is exemplary only and not intended to be limiting. The present invention is able to enhance color images or a specific component thereof.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method for uniformly enhancing images, comprising steps of:
(1) obtaining an inputted image to be enhanced, if the inputted image is a color image, transforming the color image from RGB space into YUV space, dividing a grayscale image of the Y component of the color image into a plurality of identical-sized image blocks block_{m×n}; if the inputted image is a grayscale image, dividing the grayscale image into identical-sized image blocks block_{m×n}; wherein m and n indicate a size of the image block;
(2) computing an average grayscale value of each image block mean_value comparing a uniform grayscale value gray_value which is pre-computed with the average grayscale value of the image block and then obtaining a scaling coefficient; and
(3) multiplying all pixels or specific pixels within the image block by the scaling coefficient as showed in a following formula,
$${block}_{post} = {block}_{pre} \frac{gray\_value}{mean\_value}$$
wherein blockₚᵣₑ indicates an original pixel value of the pixel within the image block and blockₚₒₛₜ indicates the pixel value of the pixel after enhancement within the image block.

2. The method, as recited in claim 1, wherein, if the two neighbor image blocks have an overlap after the step (1), all pixels within the image block are multiplied by the correspondent scaling coefficient in the step (3); and if the two neighbor image blocks have no overlap after the step (1), only specific pixels are multiplied by the correspondent scaling coefficient in the step (3), wherein the specific pixels comprise the pixels around a physical center of the image block.

3. The method, as recited in claim 2, wherein the image blocks to be enhanced are obtained via a sliding window for diving the image.

4. The method, as recited in claim 1, wherein the uniform grayscale value gray_value is an actual or expected average grayscale value of the grayscale image.

5. The method, as recited in claim 3, wherein when a quantity of the pixels which the sliding window slides over each time, namely the moving pixel step l of the two neighbor image blocks, is smaller than m, the pixels around the physical center of the image block comprises the l*l pixels around the physical center of the image block.

6. The method, as recited in claim 5, wherein the step (2) comprises repeatedly using a sum of the grayscale values of the pixels of the overlap between the former image block and the latter image block to reduce an algorithm load of computing an average grayscale value the latter image block mean_value.

7. The method, as recited in claim 6, wherein, when the moving pixel step of the two neighbor image blocks l is 1, the sum of the grayscale values of the pixels within the latter image block is equal to the sum of the grayscale values of last m−1 columns of the former image block and a last column of the latter image block.

8. A device for uniformly enhancing images, comprising a control unit, a lined cache controller, a lined storage array, an average grayscale computing unit, a scaling coefficient computing unit and an enhancement computing unit, wherein
said control unit is for generating signals for controlling the device and obtaining an inputted grayscale image, i.e., an image to be enhanced, from an external; said grayscale image to be enhanced is stored into said lined storage array through said lined cache controller; and lined storage data is parallel outputted into said average grayscale computing unit under a control by said lined cache controller;
said average grayscale computing unit comprises a column adder, a PE unit and a shift register array having a depth of m; said average grayscale computing unit value computes an average grayscale mean_value of each image block_{m×n} according to said received lined storage data, wherein m and n indicate a size of said image block;
said scaling coefficient computing unit computes scaling coefficients according to a uniform grayscale value gray_value which is pre-computed and said average grayscale mean_value of each said image block block_{m×n}; and
said enhancement computing unit comprises a delaying unit and a multiplier; said scaling coefficients are aligned with the correspondent image blocks of the inputted image to be enhanced which is delayed by the delaying unit and said aligned scaling coefficients are multiplied by said pixels within said image block in said multiplier, so as to accomplish enhancing said image.

9. The device, as recited in claim 8, wherein said image blocks to be enhanced are obtained via a sliding window, which means that only a part of said image to be enhanced is stored in said lined storage array in any given time; a quantity of bars of said lined storage array is identical to a quantity of rows of said image blocks to be enhanced; and via a sliding track of said sliding window of said image to be enhanced, said image blocks to be enhanced are obtained from said lined storage array.

10. The device, as recited in claim 9, wherein said PE unit for accomplishing a computation of a sum of grayscale values of each said image block comprises a and substractor unit, an adding unit, a register sum_value and a diving unit;
when a quantity of said pixels which said sliding window slides over each time, namely a moving pixel step l of said two neighbor image blocks, is one pixel, said computation of said average grayscale value of each said image block by said average grayscale computing unit comprises:
a computation of an average grayscale value of an image block Block1 comprising that said column adder computes a sum of grayscale values of each column of said image block Block1, accumulates said sum of each said column of said image block Block1 in said register sum_value of said PE unit, and stores said sum of said grayscale values of each said column in said shift register array having said depth of m, wherein a width of said shift register array is decided by a data width of sum_col; that after m clock cycles, a computation of a sum of grayscale values of column m of said image block Block1 is finished, when said accumulated value sum_value is a sum of grayscale values of all pixels within said image block Block1; and that said dividing unit of said PE unit divides sum_value by a quantity of said pixels within said image block sum_value m×n to obtain said average grayscale value of said image block Block1;
a computation of an average grayscale value of an image block Block2 which moves one pixel step relative to said image block Block1 at a clock cycle m+1 comprising that said subtractor unit computes a difference between a current output value shift_reg_out of said shift register array and a current output value sum_col of said column adder; that said adding unit adds said difference to a value of said register sum_value to obtain a sum of grayscale values of said image block Block2 which is still stored in said register sum_value; and that said dividing unit of said PE unit divides said sum of said grayscale values of said image block Block2 by a quantity of pixels within said image block Block2 to obtain said average grayscale value of said image block Block2, wherein said current value of said column adder sum_col is a sum of grayscale values of a last column of said image block Block2 and said current value of said shift register array shift_reg_out is a sum of grayscale values of a first column of said image block Block1; and
computations of average grayscale values of next neighbor image blocks are accomplished as said computation of said average grayscale value of said image block Block2.
